(19) United States
(12) Patent Application Publication
(10) Pub. No.: US 2026/0000169 A1
(43) Pub. Date: Jan. 1, 2026

(54) Standing Parasol with a Connection Device for Releasably Attaching a Power Load

(71) Applicant: Glatz AG, Frauenfeld (CH)

(72) Inventor: Denis Herrmann, Winterthur (CH)

(73) Assignee: Glatz AG, Frauenfeld (CH)

(21) Appl. No.: 19/076,143

(22) Filed: Mar. 11, 2025

(30) Foreign Application Priority Data
Mar. 11, 2024 (DE) 202024101177.5

(51) Int. Cl. A45B 23/00; H01R 13/625

(52) U.S. Cl. CPC A45B 23/00; H01R 13/625; A45B 2200/1009

(57) ABSTRACT

A standing parasol (1) comprises a connection device (2) for releasably attaching a power load (4) onto a parasol component (6) of the standing parasol (1), wherein the connection device (2) comprises a first coupling part (8) being electrically and mechanically operatively connected to the power load (4) and a second coupling part (10) being electrically and mechanically operatively connected to the parasol component (6). By moving the first and second plug members (12, 14) towards each other, an inserted plug position providing an electrically operative connection between the first coupling part (8) and the second coupling part (10) is achievable. By pivoting the first coupling part (8) with respect to the second coupling part (10), a change between an axially released plug position and an axially locked plug position of the connecting device (2) is achieved.

### CROSS-REFERENCE TO RELATED APPLICATION

This application claims priority from German patent application No. DE202024101177.5, filed Mar. 11, 2024, the entire disclosure of which is incorporated by reference herein.

### TECHNICAL FIELD

The invention relates to a standing parasol.

### BACKGROUND OF THE INVENTION

Standing parasols in the form of sunshades are primarily used to protect against excessive sunlight and heat. However, in temperate climates, such parasols are also used as protection against the cold, for example in the evening hours or in cool weather. In addition to a passive protective effect achieved through reduced heat radiation and, if applicable, through rain protection, active measures in the form of various heat sources are also commonly used. In particular, persons who are outdoors under a parasol can be protected from undesirable hypothermia by installing one or more radiant heaters in the parasol area.

For example, DE 102008027408 A1 describes a modular radiant heater with a plurality of heat sources, which are intended particularly for use on a standing parasol. In particular, electrically powered infrared beamers are mentioned as radiant heaters, which can be attached to a supporting element of the standing parasol. Further details on the type of mechanical attachment of the radiant heater and the connection to a power source are not given.

DE 102008019473 A1 describes a folding parasol provided with radiant heaters. This parasol comprises a central mast tube, in the upper area of which at least one radiant heater powered by electrical energy is attached, which radiates its heat laterally.

Particularly in the case of larger standing parasols such as those used in hospitality industry, hotel industry, but also for break areas or recreational areas outside of commercial buildings it would be desirable to enable a reliable and quick attachment and removal of the radiant heaters or of any other power consumers. In particular, no tools such as screwdrivers or electric pliers should be required.

### SUMMARY OF THE INVENTION

An object of the invention is therefore to propose an improved standing parasol comprising a connection device for releasably attaching a power load onto a parasol component of the standing parasol, which can overcome the weaknesses of the prior art.

The standing parasol according to the present invention is is equipped with a connection device for releasably attaching a power load onto a parasol component of the standing parasol. The connection device comprises a first coupling part being electrically and mechanically operatively connected to the power load and a second coupling part being electrically and mechanically operatively connected to the parasol component. The first coupling part comprises a first plug member with a first plug axis A′, and the second coupling part comprises a second plug member with a second plug axis. The connection device is configured in such manner that by moving the first and second plug members towards each other when the first and second plug axes A′, A″ are coaxially aligned, an inserted plug position providing an electrically operative connection between the first coupling part and the second coupling part is achieved, wherein by pivoting the first coupling part with respect to the second coupling part about the coaxially aligned first and second plug axes A′, A″ a change between an axially released plug position and an axially locked plug position of the connecting device is achieved.

This allows to avoid at least the disadvantages mentioned above.

The term “standing parasol” is to be understood in the broadest sense, but includes in particular various types of mast-supported parasols for outdoor use, in particular parasols with parasol struts.

The terms “operatively connected” or “operatively connectable” is to be understood in such manner that a mechanical and electrical connection exists or can be established that ensures reliable mechanical cohesion in the context of the intended use and a secure electrical coupling that is insulated from the environment. For the application of a standing parasol with a radiant heater, the relevant components should therefore remain connected to each other without wobbling and even in the event of wind influence, and an electrical supply of the radiant heater, for example with 230 V mains voltage, should be guaranteed also in an outdoor environment.

Geometric terms such as “coaxial”, “horizontal” or “vertical” are not to be understood in the strict geometric sense, but rather within the scope of the usual technical tolerances,

According to an advantageous embodiment, the first and second plug members are configured in such manner that, in the axially locked plug position, coaxial movement away from each other is prevented by mutually protruding projections, whereas, in the axially released plug position, coaxial movement away from each other is enabled by provided recesses.

It is particularly advantageous in the present field of application if the axially released plug position is present at a predetermined release pivoting angle α0 about the coaxially aligned first and second plug axes A′, A″ and if the axially locked plug position is present in a locking pivoting angle range α1 to α2 about the coaxially aligned first and second plug axes A′, A″, wherein the releasing pivoting angle α0 lies outside of the locking pivoting angle range α1 to α2.

In other words, it is only possible to move the two coupling parts towards each other or away from each other when there is a certain mutual alignment about the plug axes, which is defined by the said release pivoting angle α0. It will be understood that for practical reasons the released position is present over a certain tolerance range of a few angular degrees. This also promotes the moving of the two coupling parts towards each other. In contrast, the axially locked plug position is given in an entire range α1 to α2 of the pivoting angle α. Without restricting generality, the release pivoting angle α can be defined as 0°.

In some embodiments, the locking pivoting angle range then covers a value range of 45° to 135° in relation to the releasing pivoting angle α0.

For a practical definition of the pivoting angle α it can be useful to assign a longitudinal axis L1 or L2, respectively, to each of the two plug members, whereby each of these longitudinal axes is orthogonal to the respective plug axis A′ or A″, respectively. The pivoting angle α can thus be defined as an angle between the longitudinal axes L1 and L2. The direction of the longitudinal axis in a plug member is imposed in the case of elongated plug members, although it is generally freely selectable. In any case, it shall be understood that for a comparative discussion of pivoting positions or pivoting angles, respectively, the same selection of the longitudinal axes L1 and L2 is always assumed.

It is also advantageous, if a transition from the axially locked plug position to the axially released plug position is prevented or enabled by a releasable rotation lock. In particular, this can be achieved by a suitable snap-in or engaging mechanism, which, for example, comprises a spring-loaded operating member.

In some embodiments, a first electrical cable connection is arranged between the first plug member and the power load. It will be understood that especially with regard to outdoor use an appropriately configured cable must be used.

Moreover, in some embodiments, a second electrical cable connection is arranged between the second plug member and the parasol component. In particular, this may be an electrical cable connection within a structural element such as a parasol strut designed as a hollow profile, which leads to a power socket.

According to a further advantageous embodiment, the first coupling part is provided with a mounting element for the power load, which is pivotable, about a pivot axis being substantially orthogonal to the first plug axis A′, between a basic position and a tilted rest position, wherein the basic position and the rest position are held by releasable holding means. This allows the power load to be tilted into a basic position that is better protected against external influences.

According to an advantageous embodiment, the parasol component is a parasol strut.

It is particularly advantageous, if the parasol strut is aligned approximately vertically when the standing parasol is closed and is aligned at an angle φ of 45° to 90° from the vertical when the standing parasol is open. This will henceforth be described in more detail using an exemplary embodiment described with figures.

According to an advantageous embodiment, the power load is a radiant heater. In some embodiments, the radiant heater is operated with 230 V mains current.

The aforementioned elements as well as those claimed and described in the following exemplary embodiments, to be used according to the invention, are not subject to any particular conditions by way of exclusion in terms of their size, shape, use of material and technical design, with the result that the selection criteria known in the respective field of application can be used without restrictions.

### BRIEF DESCRIPTION OF THE DRAWINGS

Further details, advantages and features of the object of the present invention will become apparent from the following description and the corresponding drawings, in which the connection system according to the present invention is illustrated by way of example. In the drawings, there are shown in:

FIG. 1 a standing parasol comprising a connection device for releasably attaching a power load onto a parasol component, in a perspective view;

FIG. 2 the second coupling part of the connection device of FIG. 1, in an exploded view;

FIG. 3 the connection device of FIG. 1, in a first pivoting position, in top view;

FIG. 4 the connection device of FIG. 1, in a second pivoting position, in top view;

FIG. 5 the connection device of FIG. 1, in a third pivoting position, in top view;

FIG. 6 the connection device according to FIG. 1 comprising an associated radiant heater, in a decoupled, mutually displaced state, in a perspective view;

FIG. 7 the first coupling part of the connection device, including radiant heater of FIG. 6, in an exploded view;

FIG. 8 the connection device of FIG. 6 comprising a radiant heater and a parasol strut, in mutually displaced state, in a perspective view;

FIG. 9 the connection device comprising radiant heater and parasol strut of FIG. 8, in mutually connected state, in the axially released plug position at a predetermined release pivoting angle, in a perspective view;

FIG. 10 the connection device comprising radiant heater and parasol strut of the FIG. 9, in mutually connected state, in an axially locked plug position, in a first pivoting position of the locking pivoting angle range, in a perspective view;

FIG. 11 the connection device comprising radiant heater and parasol strut of FIG. 10, with the radiant heater being tilted into a rest position, in a perspective view; and

FIG. 12 the connection device comprising radiant heater and parasol strut of the FIG. 10, in a second pivoting position of the locking pivoting angle range, with the parasol strut being inclined, in a perspective view.

### DETAILED DESCRIPTION OF THE PREFERRED EMBODIMENTS OF THE INVENTION

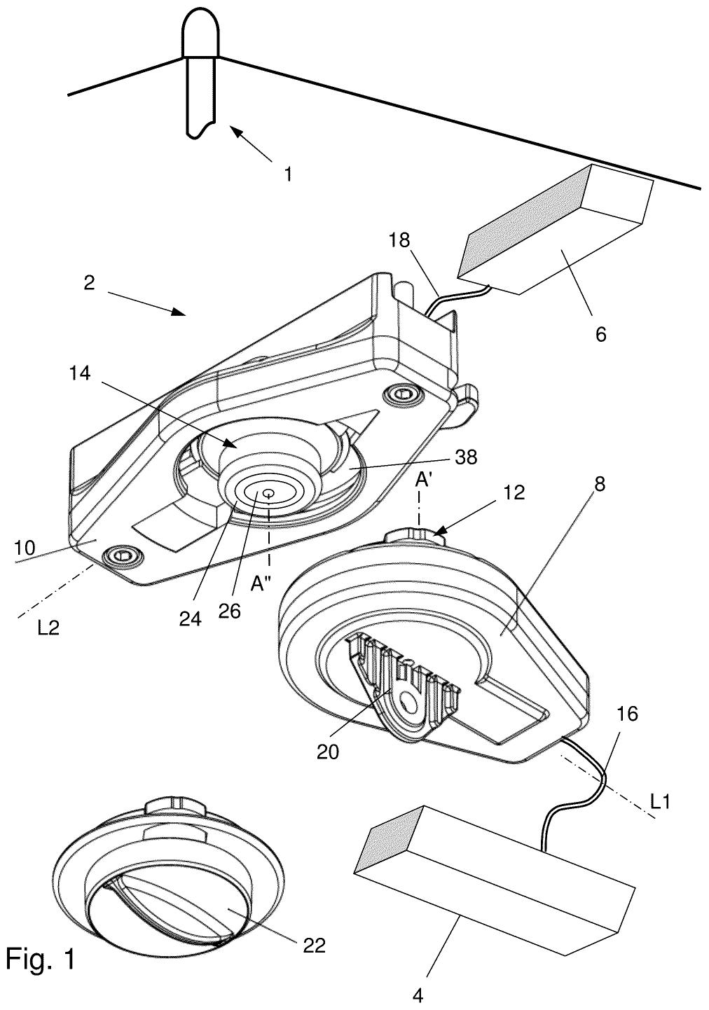

The standing parasol 1 shown but schematically in FIG. 1 is provided with a connection device generally referred to as 2. This provides a releasable attachment of a power load 4 onto a parasol component 6 of the standing parasol 1. The connection device 2 comprises a first coupling part 8 being electrically and mechanically operatively connectable to the power load 4, and a second coupling part 10 electrically and mechanically operatively connectable to the parasol component 6. The first coupling part 8 comprises a first plug member 12 with a first plug axis A′. The second coupling part 10 comprises a second plug member 14 with a second plug axis A″. The connection device 2 is configured in such manner that by moving the first plug member 12 and second plug members 14 towards each other an inserted plug position not shown in FIG. 1 is achievable when the first and second plug axes A′, A″ are coaxially aligned, which are therefore also collectively referred to as plug axis A.

As can also be seen from FIG. 1, for the first plug member 8 a first longitudinal axis L1 is specified and for the second plug member 10 a second longitudinal axis L2 is specified.

In the inserted plug position, an electrically operative connection between the first coupling part 8 and the second coupling part 10 is achieved by means of correspondingly interacting contact surfaces.

In the example shown, a first electrical cable connection 16 is arranged between the first plug member 12 and the power load 4. Moreover, a second electrical cable connection 18 is arranged between the second plug member 14 and the parasol component 6.

Moreover, the first coupling part 8 is equipped with a mounting protrusion on its side facing away from the first plug member 12 for attaching thereto the power load 4.

Finally, FIG. 1 also shows a protective cap 22, which can be attached onto the second plug member 14 instead of the first plug member 12. In particular, this allows, after removing the first coupling part 8, to counteract an undesirable soiling of a second coupling part 10 of the standing parasol 1 being left in the open.

As can be seen from FIGS. 1 and 6, the second plug member 14 comprises a plug-like inner piece 24 with a centered contact socket 26, while the first plug member 12 correspondingly comprises a sleeve-shaped inner piece 28 with a centered contact pin 30. Plug connections of a similar type are used, for example, in water kettle devices for household purposes.

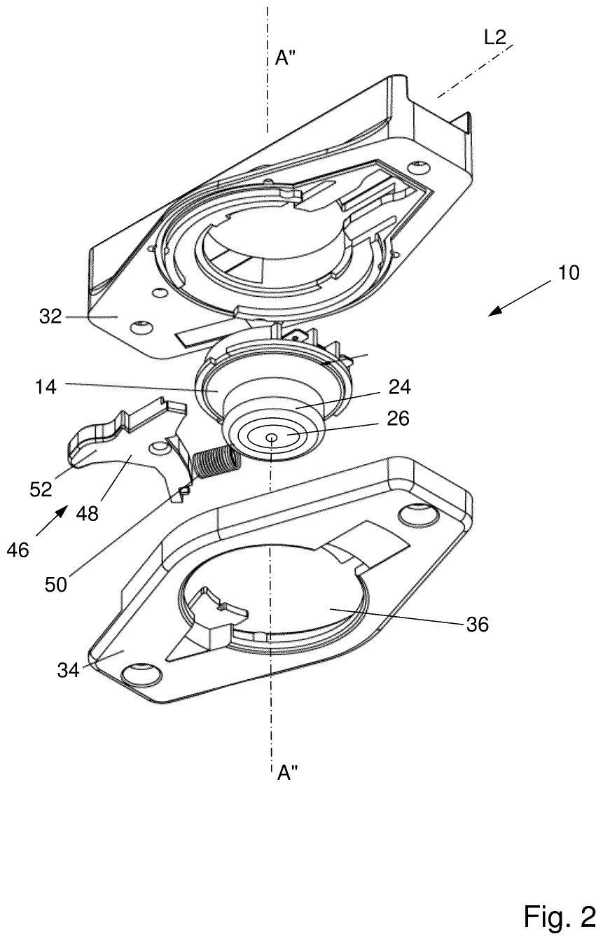

In the exploded view of FIG. 2, the basic structure of the second coupling part 10 can be seen. The second plug member 14 is received between a socket part 32 and a cover part 34 screwed thereto. The cover part 34 is provided with a substantially circular opening 36, which leaves out a ring region 38 around the pluglike inner piece 24. Further details of the second coupling part 10 are explained below.

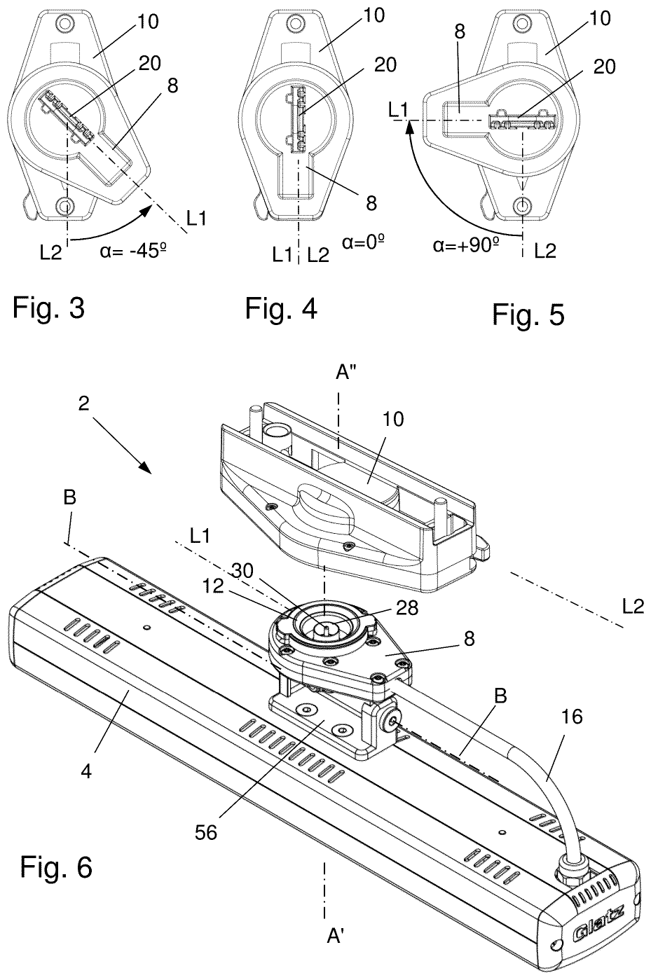

The mutual pivotability of the two coupling parts is shown in FIGS. 3 to 5, whereby the pivoting angle between the first longitudinal axis L1 and the second longitudinal axis L2 is referred to as α. In the embodiment shown here, the axially released plug position according to FIG. 3 is present at a pivoting angle α=−45°. In this situation, the two coupling parts 8, 10 can be axially moved towards each other or away from each other. By turning clockwise, a transition to the axially locked plug position takes place, whereby after turning by 45°, the pivoting position shown in FIG. 4 with parallel alignment of the first and second longitudinal axes L1 and L2 is reached. By further turning clockwise by 90°, the pivoting position shown in FIG. 5 with a rectangular alignment of the first and second longitudinal axes L1 and L2 is reached. The axially locked plug position is present in a locking pivoting angle range of at least α=0° to α=90°. Advantageously, for the positions at α=0° and α=90°, corresponding engagements are provided. In the example shown, this is achieved by a ring-shaped collar 40 of the first plug member 12, which is provided with a first projection 42 and a second projection 44. The positions at α=0° and α=90° are held in a force-releasable manner by engaging one of the two projections 42, 44 into a corresponding projection of the second coupling part 10.

As shown particularly in FIG. 2, a releasable rotation lock 46 is to be actuated for the transition from the axially locked plug position to the axially released plug position, i.e. for leaving the locking pivoting angle range α=0° to α=90°to reach back to the release pivoting angle α=−45°. In the exemplary embodiment shown, the releasable rotation lock 46 comprises a yoke-shaped swivel clamp 48 with a retaining spring 50 and an operating lever 52.

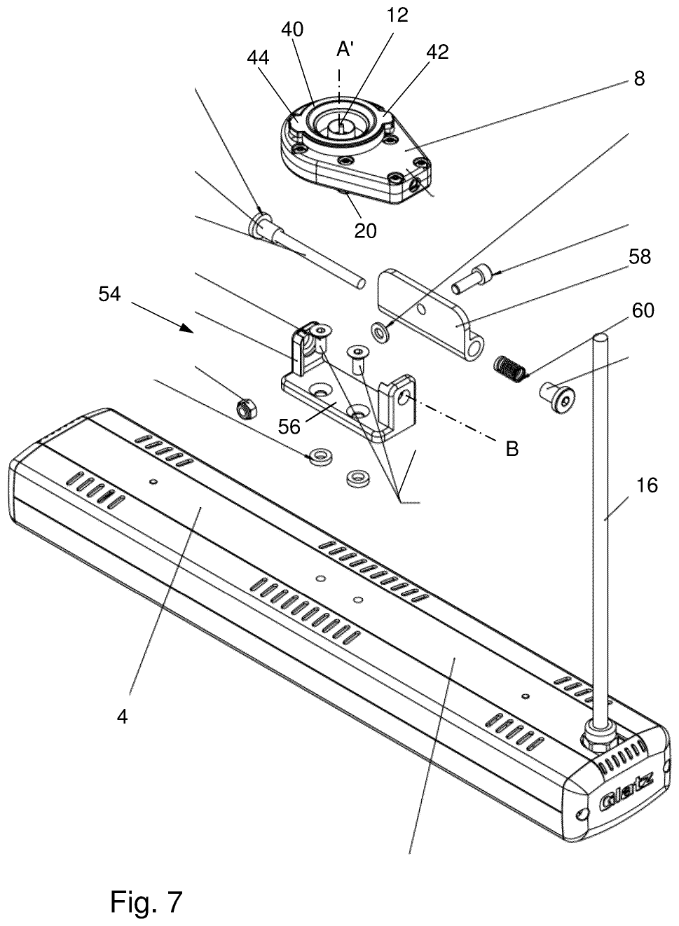

FIGS. 6 and 7 show, by way of example, an embodiment comprising a power load 4 that is configured as a radiant heater. As can be seen particularly in FIG. 7, the first coupling part 8 can be connected via a mounting projection 20 to a mounting element for the power load 4, referred to in its entirety as 54. In the example shown, mounting element 54 comprises a holder 56 that can be screwed onto the radiant heater 4 and a hinged pivot plate 58 that can be screwed to the mounting projection 20. In the assembled state, the holder 56 is pivotable about a substantially orthogonal pivot axis B with respect to the pivot plate 58 and thus with respect to the first plug axis A′. As a result, the radiant heater 4 can be pivoted between a basic position (as shown in FIG. 7) and a tilted rest position serving to protect the radiant heater when not in use. Appropriately, the basic position as well as the rest position are held by releasable holding means. In the example shown, this is achieved by axially displaceability of the pivot plate 58 along the pivot axis B between a holding position and a release position. In the respective holding position, the pivot plate 58 engages in a corresponding notch of the holder 56 and remains there due to the action of a pressure spring 60 until it is pushed out of the notch and thus into the release position by an axial force.

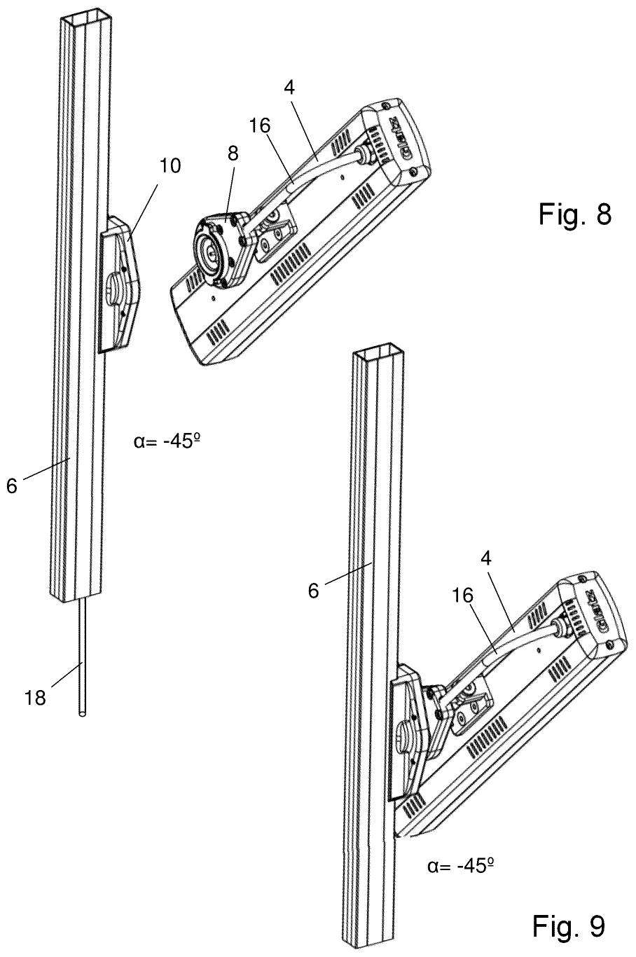

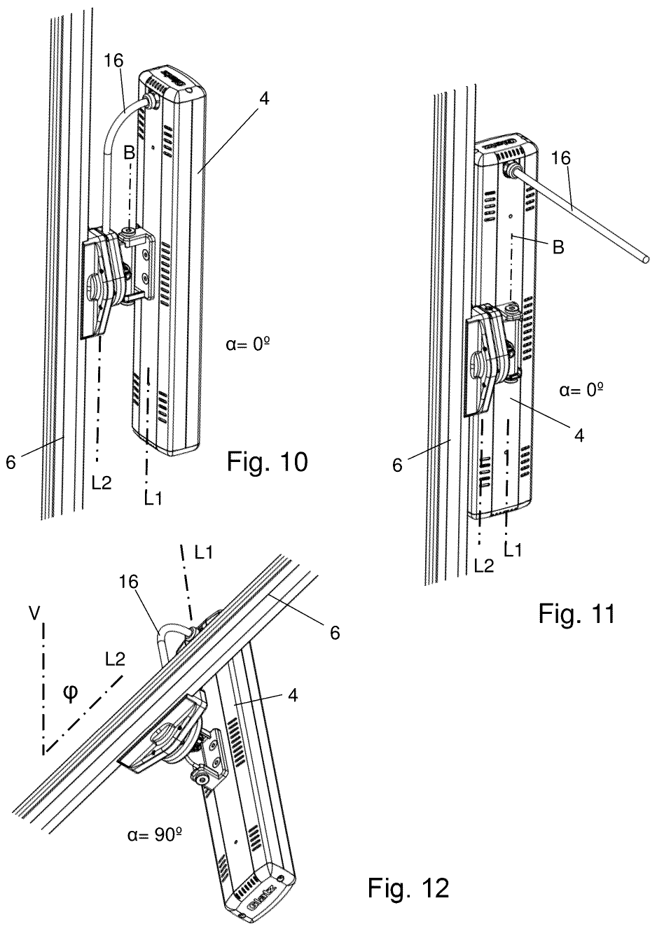

The practical handling of a standing parasol comprising parasol strut 6 and radiant heater 4 is shown in FIGS. 8 to 12.

### LIST OF REFERENCE NUMERALS

1 standing parasol
2 connection device
4 power load
6 parasol component (parasol strut)
8 first coupling part
10 second coupling part
12 first plug member
14 second plug member
16 first electrical cable connection
18 second electrical cable connection
20 mounting projection for 4
22 protective cap
24 plug-like inner piece of 14
26 contact socket of 14
28 sleeve-shaped inner piece of 12
30 contact pin of 12
32 socket part of 10
34 cover part of 10
36 opening
38 ring region
40 ring-shaped collar of 12
42 first projection
44 second projection
46 releasable rotating protection
48 swivel clamp
50 retaining spring
52 operating lever
54 mounting element for 4
56 holder of 54
58 pivot plate of 54
60 pressure spring
A′ first plug axis
A″ second plug axis
B pivot axis
L1 longitudinal axis of 8
L2 longitudinal axis of 10

1. Standing parasol comprising a connection device for releasably attaching a power load onto a parasol component of the standing parasol, wherein the connection device comprises a first coupling part being electrically and mechanically operatively connected to the power load and a second coupling part being electrically and mechanically operatively connected to the parasol component, characterized in that the first coupling part comprises a first plug member with a first plug axis (A′), the second coupling part comprises a second plug member with a second plug axis (A″), the connection device being configured in such manner that by moving the first and second plug members towards each other, an inserted plug position providing an electrically operative connection between the first coupling part and the second coupling part is achievable when the first and second plug axes (A′, A″) are coaxially aligned, and wherein by pivoting the first coupling part with respect to the second coupling part about coaxially aligned first and second plug axes (A′, A″) a change between an axially released plug position and an axially locked plug position of the connecting device is achieved.

2. Standing parasol according to claim 1, wherein the first and second plug members are configured in such manner that, in the axially locked plug position, a coaxial movement away from each other is prevented by mutually abutting projections, whereas, in the axially released plug position, a coaxial movement away from each other is enabled by provided recesses.

3. Standing parasol according to claim 2, wherein the axially released plug position is present at a predetermined release pivoting angle (α0) about the coaxially aligned first and second plug axes (A′, A″) and wherein the axially locked plug position is present in a locking pivoting angle range (α1 to α2) about the coaxially aligned first and second plug axes (A′, A″), wherein the releasing pivoting angle (α0) lies outside the locking pivoting angle range (α1 to α2).

4. Standing parasol according to claim 3, wherein the locking pivoting angle range (α1 to α2) covers a value range of 45° to 135° in relation to the releasing pivoting angle (α0).

5. Standing parasol according to claim 1, wherein a transition from the axially locked plug position to the axially released plug position is prevented or enabled by a releasable rotation lock.

6. Standing parasol according to claim 1, wherein a first electrical cable connection is arranged between the first plug member and the power load.

7. Standing parasol according to claim 1, wherein a second electrical cable connection is arranged between the second plug member and the parasol component.

8. Standing parasol according to claim 1, wherein the first coupling part is provided with a mounting element for the power load, which is pivotable, about a pivot axis (B) being substantially orthogonal to the first plug axis (A′), between a basic position and a tilted rest position, wherein the basic position and the rest position are held by releasable holding means.

9. Standing parasol according to claim 1, wherein the parasol component a parasol strut.

10. Standing parasol according to claim 1, wherein the parasol strut is aligned approximately vertically when the standing parasol is closed and is aligned at an angle (φ) of 45° to 90° to the vertical when the standing parasol is open.

11. Standing parasol according to claim 1, wherein the power load is configured as a radiant heater.

12. Standing parasol according to claim 2, wherein a transition from the axially locked plug position to the axially released plug position is prevented or enabled by a releasable rotation lock.

13. Standing parasol according to claim 3, wherein a transition from the axially locked plug position to the axially released plug position is prevented or enabled by a releasable rotation lock.

14. Standing parasol according to claim 4, wherein a transition from the axially locked plug position to the axially released plug position is prevented or enabled by a releasable rotation lock.

15. Standing parasol according to claim 2, wherein the first coupling part is provided with a mounting element for the power load, which is pivotable, about a pivot axis (B) being substantially orthogonal to the first plug axis (A′), between a basic position and a tilted rest position, wherein the basic position and the rest position are held by releasable holding means.

16. Standing parasol according to claim 3, wherein the first coupling part is provided with a mounting element for the power load, which is pivotable, about a pivot axis (B) being substantially orthogonal to the first plug axis (A′), between a basic position and a tilted rest position, wherein the basic position and the rest position are held by releasable holding means.

17. Standing parasol according to claim 4, wherein the first coupling part is provided with a mounting element for the power load, which is pivotable, about a pivot axis (B) being substantially orthogonal to the first plug axis (A′), between a basic position and a tilted rest position, wherein the basic position and the rest position are held by releasable holding means.

18. Standing parasol according to claim 5, wherein the first coupling part is provided with a mounting element for the power load, which is pivotable, about a pivot axis (B) being substantially orthogonal to the first plug axis (A′), between a basic position and a tilted rest position, wherein the basic position and the rest position are held by releasable holding means.

19. Standing parasol according to claim 6, wherein the first coupling part is provided with a mounting element for the power load, which is pivotable, about a pivot axis (B) being substantially orthogonal to the first plug axis (A′), between a basic position and a tilted rest position, wherein the basic position and the rest position are held by releasable holding means.

20. Standing parasol according to claim 7, wherein the first coupling part is provided with a mounting element for the power load, which is pivotable, about a pivot axis (B) being substantially orthogonal to the first plug axis (A′), between a basic position and a tilted rest position, wherein the basic position and the rest position are held by releasable holding means.
